(19) United States
(12) Patent Application Publication
(10) Pub. No.: US 2008/0111329 A1
(43) Pub. Date: May 15, 2008

(54) Dolly Cart

(76) Inventors: Edmund W. Brown, Racine, WI (US); Ryan E. Brown, Racine, WI (US)

Correspondence Address: BOYLE FREDRICKSON S.C., 840 North Plankinton Avenue, MILWAUKEE, WI, 53203, US

(21) Appl. No.: 11/558,520

(22) Filed: Nov. 10, 2006

(51) Int. Cl. B62D 39/00

(52) U.S. Cl. 280/33.997

(57) ABSTRACT

A dolly cart is provided for transporting a load over a supporting surface. The dolly cart includes a support frame having a first and second ends. A wheel assembly is operatively connected to the support frame for supporting the support frame above a supporting surface. A striker element is operatively connected to the first end of the support frame. The striker element is pivotable between a first position wherein the striker element is generally parallel to the supporting surface and second position wherein the striker element is at an acute angle to the supporting surface. A latch mechanism is operatively connected to the second end of the cart. The latch mechanism includes a latch member having a hooked terminal end that partially defines a recess for receiving a portion of a striker element of an adjacent dolly cart therein.

### FIELD OF THE INVENTION

This invention relates generally to wheeled carts, and in particular, to a dolly cart that may be interconnected to one of more adjacent dolly carts in order to form a train for transporting materials about a factory or the like.

### BACKGROUND AND SUMMARY OF THE INVENTION

In order to transport pallets, containers and materials throughout a factory or the like, wheeled carts are often used. These carts allow an individual to deliver the pallets, containers or materials to a desired work station in the factory. It can be appreciated that the delivery of an individual cart to various locales throughout the factory can be a time consuming and inefficient task. As such, it is highly desirable to provide a more efficient method for transporting pallets, containers and materials throughout the factory.

In order to increase the efficiency of transporting pallets, containers or materials throughout the factory, it has been contemplated to interconnect multiple carts together to form a train. By way of example, Dioguard, U.S. Pat. No. 3,561,622 discloses a train formed from a plurality of cargo trailers. A powered drive vehicle is provided as a source of power to control movement of the train of cargo trailers. Each of the cargo trailers are interconnected by a coupling means. The coupling means allow for the power generated by the drive vehicle to be translated to each cargo trailer.

The cargo train disclosed in the '662 patent is functional for its intended purpose. However, the coupling means disclosed therein for interconnecting the cargo trailers must allow for the transmission of power generated by the drive vehicle to be translated to each of the cargo trailers. For manually operated carts, such a coupling means is far too complicated and expensive to implement. As such, it is highly desirable to provide a cart that incorporates a simple means for interconnecting the another adjacent cart in order to form a train for transporting pallets, containers and materials about a factory or the like.

In addition, it can be appreciated that when a cart is situated on a factory floor or in a transport in a vehicle, it is often necessary to prevent movement of the cart along its supporting surface (e.g., the factory floor or the vehicle bed). Further, its is highly desirable to provide a simple mechanism for retaining the cart in a user desired location and for releasing the cart from such location to allow the cart to be wheeled by a user to various locales throughout the factory or off the transport vehicle.

Therefore, it is a primary object and feature of the present invention to provide a dolly cart that may be interconnected to one or more adjacent dolly carts in order to form a train for transporting materials about a factory or the like.

It is a further object and feature of the present invention to provide a dolly cart for transporting pallets, containers and materials throughout a factory that is simple to use and inexpensive to manufacture.

It is a further object and feature of the present invention to provide a dolly cart for transporting pallets, containers and materials throughout a factory that may be parked in a user-desired location so as to discourage the unwanted movement of the dolly cart from such location.

In accordance with the present invention, a dolly cart is provided for transporting a load over a supporting surface. The dolly cart includes a support frame having a first and second ends. A wheel assembly is operatively connected to the support frame for supporting the support frame above a supporting surface. A connecting arm is slidably supported by the support frame. The connecting arm is movable between an extended position and a retracted position. A striker element is pivotably connected to the connecting arm. The striker element is movable between a first position wherein the striker element is generally parallel to the supporting surface and second position wherein the striker element is at an acute angle to the supporting surface. A latch mechanism is operatively connected to the second end of the cart. The latch mechanism includes a latch member having a hooked terminal end that partially defines recess for receiving a portion of the striker element therein. The latch member is movable between an open position for allowing a striker element of an adjacent dolly cart to be inserted into and removed from the recess and a closed position for maintaining the striker element of the adjacent dolly cart in the recess.

A biasing structure urges the latch member towards the closed position. A handle is operatively connected to the connecting aim for moving the connecting arm between the extend and retracted positions. A locking element selectively maintains the connecting arm in a user selected position. The locking element includes a locking pin that is movable between a non-locking position wherein the connecting arm is movable between the retracted and extended positions and a locking position wherein the connecting arm is fixed in retracted position. The connecting arm includes an aperture therethrough. The locking pin is receivable in the aperture through the connecting arm with the connecting arm in the retracted position. The dolly cart may also include a lock handle and a push-pull cable operatively connecting the lock handle and the locking pin. The lock handle is movable between an unlocking position wherein the push-pull cable moves the locking pin to the non-locking position and a locking position.

A floor lock is operatively connected to the support frame. The floor lock is movable between a retracted position wherein the dolly cart is free to travel over the supporting surface and an extended position wherein in the floor look is engageable with the supporting surface and discourages movement of the dolly cart along the supporting surface. A bed is mounted to the support frame for receiving the load thereon. An anti-skid deck is affixed to an upper surface of the dolly cart for discouraging movement of the load supported thereon.

The striker element includes may include a bar and a ring. The bar has a first end pivotably received in a first end of the connecting aim and a second end. The ring is interconnected to the second end of the bar.

In accordance with a further aspect of the present invention, a dolly cart is provided for transporting a load over a supporting surface. The dolly cart includes a support frame having a first and second ends. A wheel assembly is operatively connected to the support frame for supporting the support frame above a supporting surface. A striker element is operatively connected to the first end of the support frame. The striker element is pivotable between a first position wherein the striker element is generally parallel to the supporting surface and second position wherein the striker element is at an acute angle to the supporting surface. A latch mechanism is operatively connected to the second end of the cart. The latch mechanism includes a latch member having a hooked terminal end that partially defines a recess for receiving a portion of a striker element of an adjacent dolly cart therein.

The terminal end of the latch member is pivotable between an open position wherein the striker element of the adjacent dolly cart may be inserted into and removed from the recess and a closed position for maintaining the striker element of the adjacent dolly cart in the recess. A biasing structure urges the latch member towards the closed position. A connecting arm is slidably supported by the support frame. The connecting arm is movable between an extended position and a retracted position.

The striker element includes a bar and a ring. The bar has a first end pivotably received in a first end of the connecting arm and a second end. The ring is interconnected to the second end of the bar. The handle is operatively connected to the connecting arm for moving the connecting arm between the extend and retracted positions. A locking element selectively maintains the connecting arm in a user selected position. The locking element includes a locking pin movable between a non-locking position wherein the connecting arm is movable between the retracted and extending positions and a locking position wherein the connecting arm is fixed in the retracted position. The connecting arm includes an aperture therethrough. The locking pin is receivable in the aperture through the connecting arm with the connecting arm in the retracted position. The dolly cart may also include a lock handle and a push-pull cable operatively connecting the lock handle and the locking pin. The lock handle is movable between an unlocking position wherein the push-pull cable moves the locking pin to the non-locking position and a locking position.

A floor lock is operatively connected to the support frame. The floor lock is movable between a retracted position wherein the dolly cart is free to travel over the supporting surface and an extended position wherein in the floor look is engageable with the supporting surface and discourages movement of the dolly cart along the supporting surface. A bed is mounted to the support frame for receiving the load thereon. An anti-skid deck is affixed to an upper surface of the dolly cart for discouraging movement of the load supported thereon.

In accordance with a still further aspect of the present invention, a dolly cart is provided for transporting a load over a supporting surface. The dolly cart includes a support frame having a first and second ends. A bed is mounted to the support frame for receiving the load thereon. A wheel assembly is operatively connected to the support frame for supporting the support frame above a supporting surface. A connecting arm is slidably supported by the support frame. The connecting arm has first and second ends and is movable between an extended position and a retracted position. A striker element is pivotably connected to the connecting arm. The striker element includes a bar and a ring. The bar has a first end pivotably received in a first end of the connecting arm and a second end. The bar is movable between a first position wherein the bar is generally parallel to the supporting surface and second position wherein the bar is at an acute angle to the supporting surface. The ring is interconnected to the second end of the bar. A latch mechanism is operatively connected to the second end of the cart. The latch mechanism includes a latch member having a hooked terminal end that partially defines a recess for receiving a ring of a striker element of an adjacent dolly cart therein. A floor lock is operatively connected to the support frame. The floor lock is movable between a retracted position wherein the dolly cart is free to travel over the supporting surface and an extended position wherein in the floor look is engageable with the supporting surface and discourages movement of the dolly cart along the supporting surface.

An anti-skid deck affixed to an upper surface of the dolly cart for discouraging movement of the load supported thereon. A handle is operatively connected to the connecting arm for moving the connecting arm between the extend and retracted positions. A locking element selectively maintains the connecting arm in a user selected position. The locking element includes a locking pin movable between a non-locking position wherein the connecting arm is movable between the retracted and extending positions and a locking position wherein the connecting arm is fixed in the retracted position. The connecting arm includes an aperture therethrough. The locking pin is receivable in the aperture through the connecting arm with the connecting arm in the retracted position. The dolly cart may also include a lock handle and a push-pull cable operatively connecting the lock handle and the locking pin. The lock handle is movable between an unlocking position wherein the push-pull cable moves the locking pin to the non-locking position and a locking position.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of first and second dolly carts in accordance with the present invention interconnected to form a train;

FIG. 2 is an enlarged, isometric view of a leading end of a dolly cart in accordance with the present invention;

FIG. 3 is an enlarged, isometric view of a trailing end of a dolly cart in accordance with the present invention;

FIG. 4 is a cross-sectional view of the dolly cart of the present invention;

FIG. 5 is an enlarged cross-sectional view showing the trailing end of the first dolly cart prior to receiving the leading end of the second dolly cart therein;

FIG. 6 an enlarged cross-sectional view showing the leading end of the second dolly cart in engagement with the trailing end of the first dolly cart;

FIG. 7 an enlarged cross-sectional view showing the leading end of the second dolly cart operatively connected to the trailing end of the first dolly cart;

FIG. 8 is an enlarged cross-sectional view showing foot brake of the first dolly cart in a non-actuated position;

FIG. 9 is an enlarged cross-sectional view showing foot brake of the first dolly cart in an actuated position; and

FIG. 10 is an enlarged, cross-sectional view showing a tow bar of the first dolly cart in an extended, locked position.

### DETAILED DESCRIPTION OF THE DRAWINGS

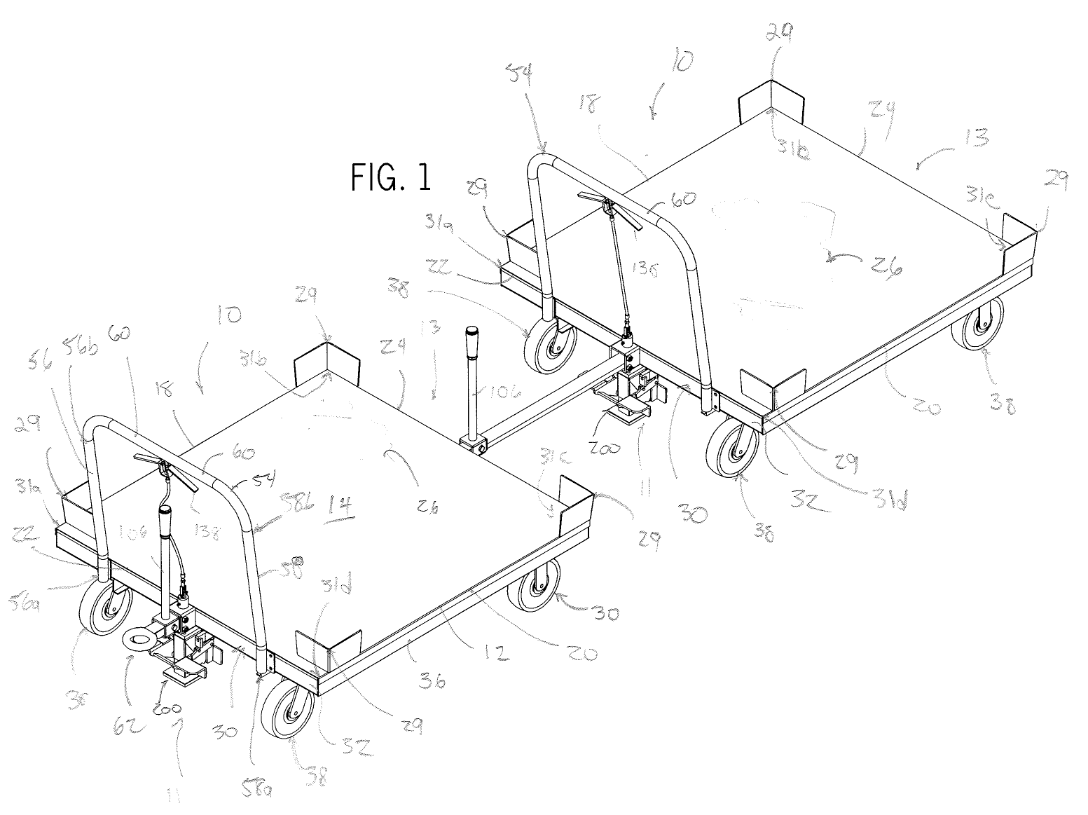

Referring to FIGS. 1 and 4, a dolly cart in accordance with the present invention is generally designated by the reference numeral 10. As hereinafter described, it is intended to interconnect a plurality of dolly carts 10 and 10a together to form a train, FIG. 1. In order to facilitate understanding of the present invention, one of the plurality of dolly carts 10 is designated as leading dolly cart 10 and one of the plurality of dolly carts 10a is designated as trailing dolly cart 10a. However, it can be appreciated that dolly carts 10 and 10a are identical in structure, and as such, the description hereinafter of leading dolly cart 10 is understood to describe trailing dolly cart 10a as if fully described herein.

Dolly cart 10 includes leading and trailing ends 11 and 13, respectively, and a generally flat base 12 defined by generally flat upper surface 14 and generally flat lower surface 16. Upper and lower surfaces 14 and 16, respectively, are interconnected by side edges 18 and 20, leading edge 22 and trailing edge 24. It is contemplated to affix an anti-skid deck 26, FIG. 1, to upper surface 14 of base 12. Anti-skid deck 26 is intended to discourage movement of a load supported thereon as dolly cart 10 travels along supporting surface 15 such as a factory floor or the like. Generally V-shaped retaining elements 29 project vertically from locations adjacent corresponding corners 31a-d of base 12. Retaining elements 29 are intended to maintain a load on upper surface 14 of platform 12.

It is contemplated that base 12 be integrally formed with a support frame to add strength and stability to dolly cart 10. Alternatively, base 12 may mounted to and supported by support frame 30. Support frame 30 includes leading and trailing ends 32 and 34, respectively, interconnect by sides 36 and (not shown). Support frame 30 may also include a plurality of additional cross-frame members (not shown) to add strength and stability to dolly cart 10. Support frame 30 is supported over supporting surface 15 by a plurality of caster assemblies 38. As is conventional, each caster assembly 38 includes a U-shaped brackets 48 depend from the lower surface 44 support frame 30. Axles 50 extend between the legs of U-shaped brackets 48 to rotatably support corresponding caster wheels 52 thereon. It is contemplated to mount each caster assembly 38 to support frame 30 about the periphery thereof.

Dolly cart 10 further includes a generally U-shaped handle 54 mounted to leading end 32 of support frame 30. Handle 54 includes spaced leg portions 56 and 58 having terminal ends 56a and 58a, respectively, interconnected to leading end 32 of support frame 30 and opposite second ends 56b and 58b, respectively, that are vertically and horizontally spaced from base 12. Second ends 56b and 58b of legs 56 and 58, respectively, are interconnected by a generally horizontal handle grasping portion 60 which allows a user to push and pull dolly cart 10 in a conventional manner.

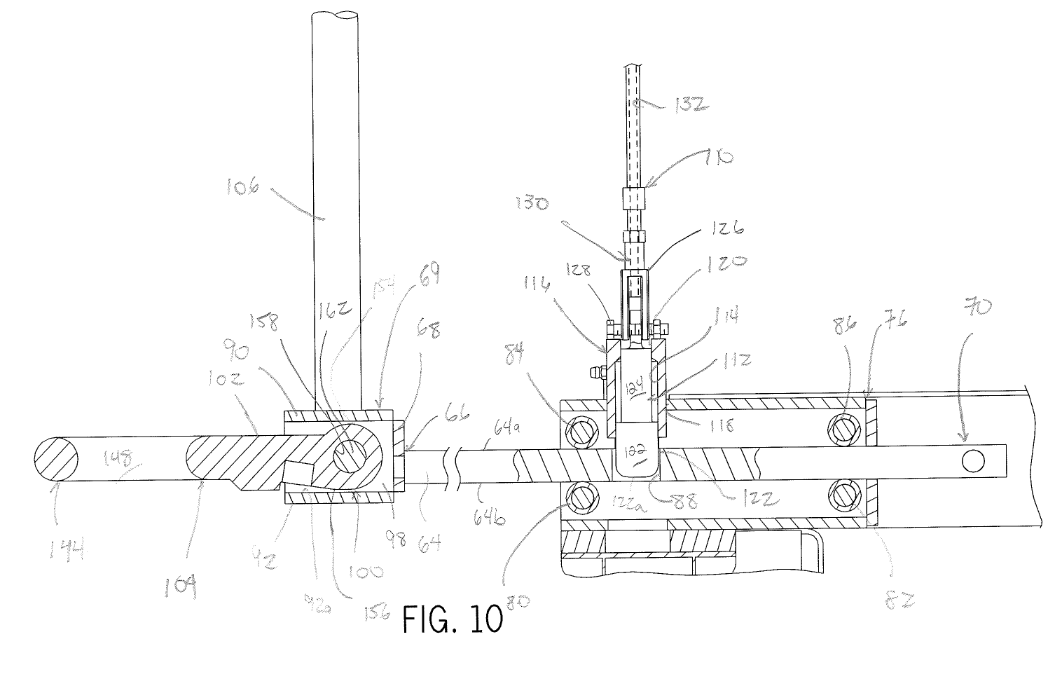

In order to interconnect leading dolly cart 10 and trailing dolly cart 10a, tow bar assembly 62 is provided. As best seen in FIGS. 4 and 10, tow bar assembly 62 includes tow bar 64 having a first end 66 rigidly connected to rear wall 68 of striker box 69 and an opposite second end 70. Tow bar 64 extends through leading end 11 of dolly cart 10 and is slideably received between upper block 72 depending from lower surface 16 of base 12 and lower block 74 connected to support frame 30. In addition, tow bar 64 extends through bearing box 76 positioned between lower surface 16 of base 12 and support frame 30 adjacent leading end 11 of dolly cart 10. Bearing box 76 includes first and second spaced, lower bearings 80 and 82, respectively, for receiving lower surface 64b of tow bar 64 thereon and first and second spaced, upper bearings 84 and 86, respectively, in engagement with upper surface 64a of tow bar 64. As described, tow bar 64 is slideable between a retracted position, FIG. 4, and an extended position, FIG. 10. Locking aperture 88 extends through tow bar 64 adjacent second end 70, for reasons hereinafter described. In addition, foot bar 71 project laterally from tow bar 64 adjacent second end 70, for reasons hereinafter described.

In order to maintain tow bar 64 in its extended position, FIG. 10, locking pin assembly 110 is provided. Locking pin assembly 110 includes locking pin 112 slidably received with cylindrical cavity 114 of locking pin cylinder 116. Locking pin cylinder 116 extends vertically through aperture 118 in bearing box 76 such that a first end of cylindrical cavity 114 communicates with the interior of bearing box 76. A second end of cylindrical cavity 114 communicates with a reduced diameter opening 120 through locking pin cylinder 116.

Locking pin 112 includes an enlarged head 122 that forms a slidable interface with the inner surface of locking pin cylinder 116 and a neck 124 that extends through and forms a slidable interface with the portion of locking pin cylinder 116 that defines opening 120. Neck 124 of locking pin 112 is interconnected to adjustment bracket 126 by bolt 128. For reasons hereinafter described, adjustment bracket 126 is adjustably connected to a first end 130 of push-pull cable 132. Second end 134 of push-pull cable 132 is connected to handle 138 which, in turn, is pivotable connected to handle grasping portion 60 of handle 54 via bolt 140 and bracket 142. By rotating handle 138 about the axis of bolt 140, push-pull cable 132 is drawn towards and away from handle grasping portion 60 of handle 54 thereby causing locking pin 112 to slide vertically along the inner surface of locking pin cylinder 116 between an extended position, FIG. 10, and a retracted position, FIG. 4.

It is contemplated to bias push-pull cable 132, and hence locking pin 112 towards it extended position. As a result, in the event that tow bar 64 is not in its extended position, terminal surface 122a of enlarged head 122 of locking pin 112 rides on upper surface 64a of tow bar 64. As tow bar 64 is moved into its extended position, locking pin 112 becomes axially aligned with aperture 88 through tow bar 64 such that locking pin 122 is urged towards its extended position wherein head 122 of locking pin 112 is urged into aperture 88 through tow bar 64, thereby locking tow bar 64 in its extended position. In order to move tow bar 64 from its locked, extended position, handle 138 is pivoted by a user about the axis of bolt 140 so as to move locking pin 112 to its retracted position, thereby freeing tow bar 64. It can be appreciated that vertical movement and position of locking pin 112 may be tuned by adjusting the connection of push-pull cable 132 to adjustment bracket 126.

Striker box 69 is defined by horizontal upper and lower walls 90 and 92, respectively, interconnected and spaced by first and second side walls 94 and 96, respectively. Upper and lower walls 90 and 92, respectively, first and second side walls 94 and 96, respectively, and rear wall 68 define a striker receipt cavity 98 for receiving a first end 100 of bar 102 of striker element 104. Handle 106 projects vertically from upper surface 108 of upper wall 90 of striker box 69. Handle 106 terminates at grip 108. Handle 106 and grip 108 facilitates movement of tow bar 64 between its retracted and its extended positions by a user.

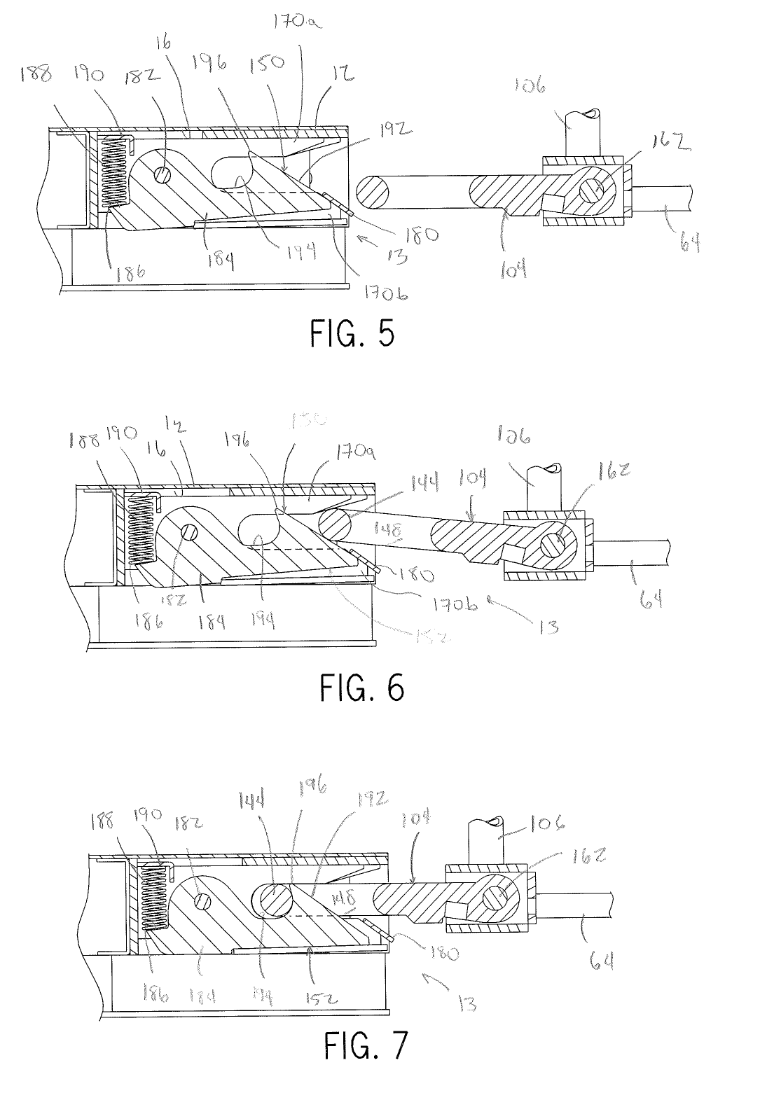

Striker element 104 is defined by bar 102 and ring 144. First end 100 of bar 102 is received with striker receipt cavity 98 as heretofore described. Second end 146 of bar 102 is rigidly connected to the outer periphery of ring 144. Ring 144 defines passageway 148 therethrough for receiving hooked portion 150 of latching element 152, as hereinafter described. First end 100 of bar 102 includes a generally cylindrical outer surface 154 having a flat portion 156 adjacent upper surface 92a of lower wall 92 of striker box 69. Cylindrical passageway 158 extends through first end 100 of bar 102 and accommodates pivot pin 162 therethrough. The ends of pivot pin 162 extends through corresponding side walls 94 and 96 of striker box 69 and retained in place by pins 164. As described, striker element 104 is pivotable on pivot pin 162 between a first generally horizontal position wherein flat portion 156 of outer surface 154 of first end 100 of bar 102 is in engagement with upper surface 92a of lower wall 92 of striker box 69, FIG. 5, and a second position wherein bar 102 extends along an axis at a generally acute angle to supporting surface 15 on which dolly cart 10 resides, FIG. 6.

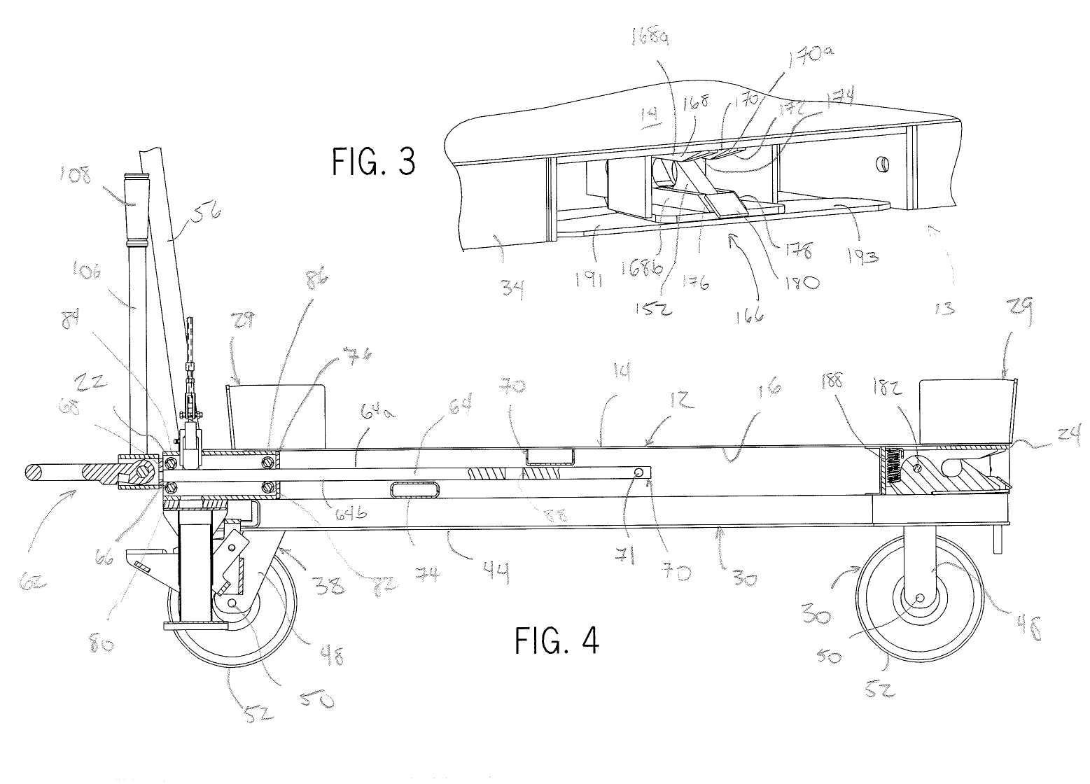

As best seen in FIGS. 3-7, dolly cart 10 further includes latch assembly 166 in trailing end 34 of support frame 30. Latch assembly 166 includes first and second laterally spaced, generally C-shaped coupling brackets 168 and 170. Coupling brackets 168 and 170 include upper tapered surfaces 172 and 174, respectively, extending from trailing edge 24 of base 12 toward the interior of support frame 30 and lower tapered surfaces 176 and 178, respectively, extending from trailing end 34 of support frame 30 toward the interior thereof. Ramp plate 180 is affixed to and overlaps lower tapered surfaces 176 and 178.

Latch element 152 is disposed between coupling brackets 168 and 170 and pivotably connected thereto by pivot pin 182. Latch element 152 includes central body 184 having hooked portion 150 projecting therefrom towards trailing end 13 of dolly cart 10. First and second release pedals 191 and 193, respectively project laterally from opposite sides of hooked portion 150 of latch element 152 and pass underneath corresponding connecting brackets 168 and 170, respectively. Hooked portion 150 has a generally flat outer surface 192 and a generally arcuate inner surface 194 that intersect at apex 196. Latch element 152 further a spring-receiving shoulder 186 projecting from central body 184 towards leading end 11 of dolly cart 10. Spring 188 extends between shoulder 186 and spring receipt bracket 190 depending from lower surface 16 of base 12. It is intended for spring 188 to urge latch element 152 towards a closed position wherein outer surface 192 of hooked portion 150 is generally co-planar with lower tapered surfaces 176 and 178 of coupling brackets 168 and 170, respectively, and wherein apex 196 of hooked portion 150 of latch element 152 is disposed between upper leg portions 168a and 170a of coupling brackets 168 and 170, respectively.

Referring specifically to FIGS. 5-7, in order to interconnect leading dolly cart 10 and trailing dolly cart 10a to form a train, leading end 11 of trailing dolly cart 10a is positioned adjacent trailing end 13 of leading dolly cart 10. Ring 144 of striker element 104 of trailing dolly cart 10a is aligned with latch assembly 166 of leading dolly cart 10, FIG. 5. Given that striker element 104 is pivotable, it can be appreciated leading and trailing dolly carts 10 and 10a, respectively, may be still be interconnected even if ring 144 of striker element 104 of trailing dolly cart 10a is not perfectly aligned with latch assembly 166 of leading dolly cart 10, Once aligned, ring 144 of striker element 104 of trailing dolly cart 10a is brought into contact with latch assembly 166 of leading dolly cart 10 such that ring 144 slides along ramp plate 180 and outer surface 192 of hooked portion 150 of latch element 152, FIG. 6. It can be appreciated that as ring 144 of striker element 104 of trailing dolly cart 10a engages outer surface 192 of hooked portion 150 of latch element 152 of leading dolly cart 10, hooked portion 150 of latch element 152 is urged against the bias of spring 188 such that latch element 152 pivots clockwise in FIG. 6. As a result, ring 144 of striker element 104 of trailing dolly cart 10a urges apex 196 of hooked portion 150 of latch element 152 of leading dolly cart 10 between lower leg portions 168b and 170b of coupling brackets 168 and 170, respectively, such that ring 144 of striker element 104 of trailing dolly cart 10a may pass over apex 196 of hooked portion 150 of latch element 152 of leading dolly cart 10. Once ring 144 of striker element 104 of trailing dolly cart 10a passes over apex 196 of hooked portion 150 of latch element 152 of leading dolly cart 10, spring 188 urges latch element 152 to its closed position such that apex 196 of hooked portion 150 of latch element 152 passes through passageway 148 defined by ring 144 of striker element 104 of trailing dolly cart 10a, FIG. 7, thereby interconnecting leading and trailing dolly carts 10 and 10a, respectively.

In order to release trailing dolly cart 10a from leading dolly cart 10, one or both of release pedals 191 and 193, respectively, are urged downwardly such that hooked portion 150 of latch element 152 is urged against the bias of spring 188 and pivots clockwise in FIG. 6. Once apex 196 of hooked portion 150 of latch element 152 of leading dolly cart 10a is urged lower leg portions 168b and 170b of coupling brackets 168 and 170, respectively, ring 144 of striker element 104 of trailing dolly cart 10a may pass over apex 196 of hooked portion 150 of latch element 152 of leading dolly cart 10.thereby disengaging the leading and trailing dolly carts 10 and 10a, respectively.

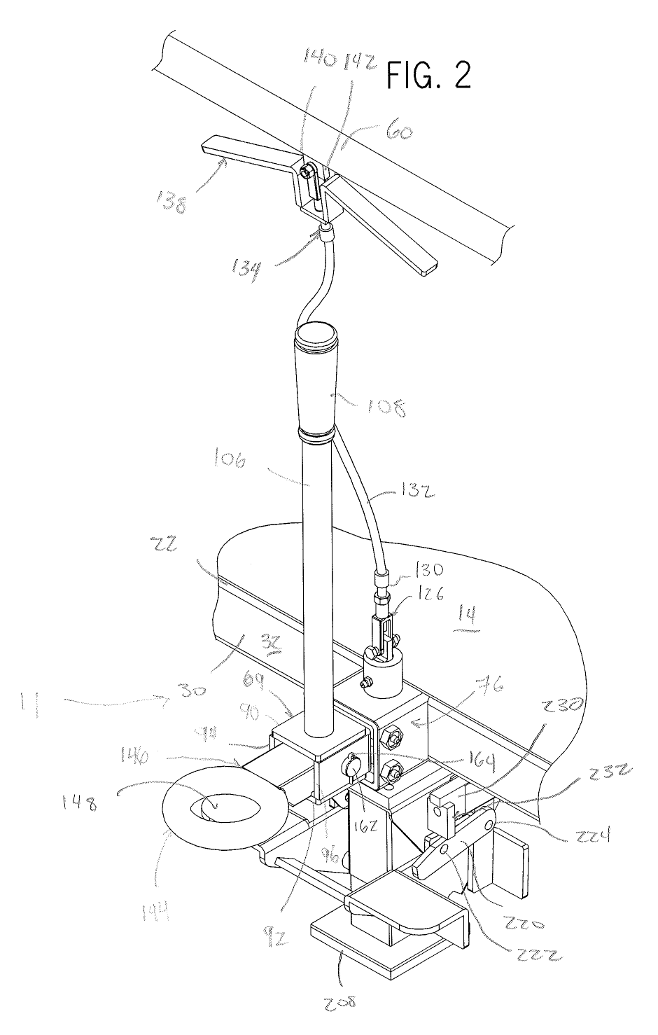

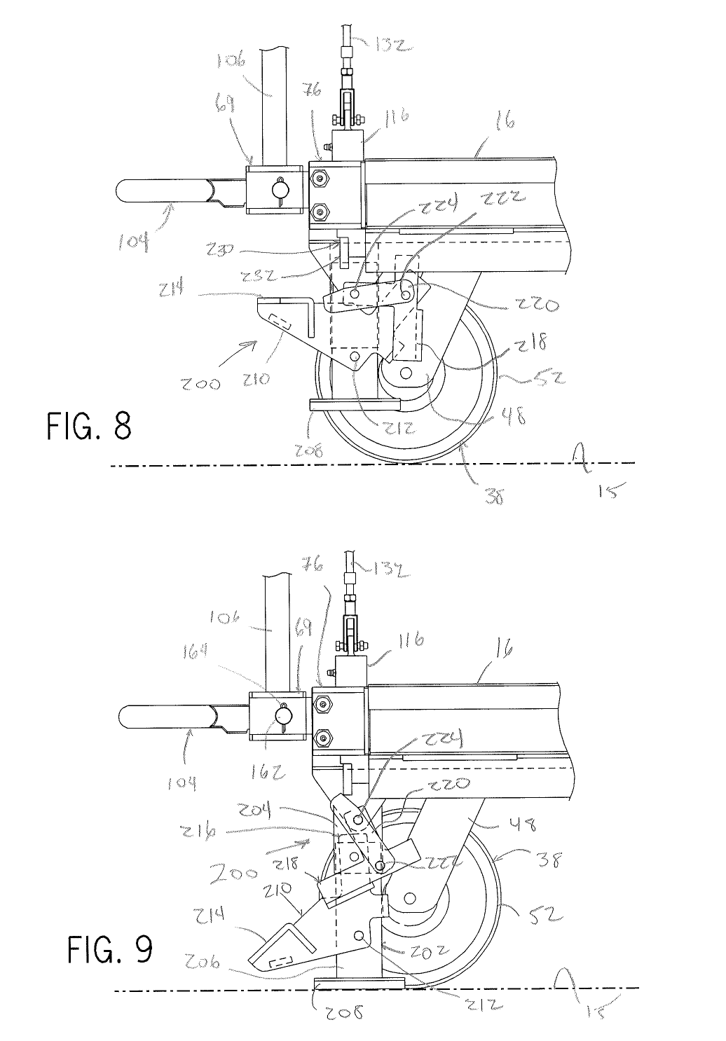

Referring to FIGS. 2 and 8-9, a floor brake for discouraging movement of dolly cart 10 over supporting surface 15 is generally designated by the reference numeral 200. Floor brake 200 includes leg 202 having a tubular upper portion 204 and a tubular lower portion 206. Upper portion 204 of leg 202 is fixed to bearing box 76 adjacent leading end 11 of dolly cart 10. Upper end of lower portion 206 of leg 202 is telescopically received within upper portion 204. A generally flat foot 208 overlaps and is fixed to the lower end of lower portion 206 of leg 202. A non-skid pad may be secured to foot 208, for reasons hereinafter described. Lower portion 206 of leg 202 is moveable between a retracted position, FIG. 8, wherein foot 208 is spaced from supporting surface 15 and an extended position, FIG. 9, wherein foot 208 is in engagement with supporting surface 15. It is contemplated to bias lower portion 202 towards its retracted position in any suitable manner such as by means of a spring or the like.

In order to move lower portion 206 of leg 202 between its retracted and extended positions, it is contemplated to pivotably connect foot pedal 210 to lower portion 206 of leg 202 at pivot point 212. Foot pedal 210 includes pedal 214 secured to a first end thereof that accommodates a foot of a user. Second end 216 of foot pedal 210 is engaeable with release pedal 218. Release pedal 218 is pivotably connected to bar 220 at pivot point 222 and at pivot point 224, which in turn, is pivotably connected to support frame 30.

In operation, foot pedal 210 may be pivoted counter-clockwise about pivot point 212. As foot pedal 210 is pivoted, second end 216 of foot pedal 210 engages and causes release pedal 218 and bar 220 to pivot about pivot point 224. It is intended for bar 218 to over pivot on pivot point 224 such that release pedal 218 retains foot pedal 210 in its pivoted position, FIG. 9. With foot pedal 210 in its pivoted position, foot 208 is in engagement with supporting surface 15. The non-skid pad secured to foot 208 discourages movement of foot 208, and hence dolly cart 10, along supporting surface 15.

In order to release foot pedal 210 from its pivoted position and allow lower portion 206 of leg 202 to return to its retracted position, it is contemplated to pivot release pedal 218 counter-clockwise about pivot point 224. As release pedal 218 is pivoted counter-clockwise about pivot point 224, bar 220 also pivots on pivot point 224 and foot pedal 210 is freed to pivot clockwise on pivot point 212. As a result, the bias of lower portion 206 of leg 202 urges foot pedal 210 to its original position and urges lower portion 206 of leg 202 towards its retracted position.

Alternatively, it is contemplated to slidably mount release bar 230 to support frame 30 at a location adjacent leading end 11 of dolly cart 10. Bar 230 is generally parallel to and adjacent tow bar 64. Leading end 232 of bar 230 projects from leading end 11 of dolly cart 10. As tow bar 64 moves from its retracted to its extended position, foot bar 71 projecting laterally from tow bar 64 engages the trailing end of release bar 230, thereby urging release bar 230 into engagement with bar 220. As a result, bar 220 pivots on pivot point 224 thereby freeing foot pedal 210 to pivot clockwise on pivot point 212. Thereafter, the bias of lower portion 206 of leg 202 urges foot pedal 210 to its original position and urges lower portion 206 of leg 202 towards its retracted position.

Various modes of carrying out the invention are contemplated as being within the scope of the following claims particularly pointing out and distinctly claiming the subject matter that is regarded as the invention.

I claim:

1. A dolly cart for transporting a load over a supporting surface, comprising:
a support frame having a first and second ends;
a wheel assembly operatively connected to the support frame for supporting the support frame above a supporting surface;
a connecting arm slidably supported by the support frame, the connecting arm movable between an extended position and a retracted position;
a striker element pivotably connected to the connecting arm, the striker element movable between a first position wherein the striker element is generally parallel to the supporting surface and second position wherein the striker element is at an acute angle to the supporting surface; and
a latch mechanism operatively connected to the second end of the support frame, the latch mechanism latch member having a hooked terminal end that partially defines a recess for receiving a portion of the striker element therein, the latch member movable between an open position for allowing a striker element of an adjacent dolly cart to be inserted into and removed from the recess and a closed position for maintaining the striker element of the adjacent dolly cart in the recess.

2. The dolly cart of claim 1 further comprising a biasing structure for urging the latch member towards the closed position.

3. The dolly cart of claim 1 further comprising a handle operatively connected to the connecting arm for moving the connecting aim between the extend and retracted positions.

4. The dolly cart of claim 1 further comprising a locking element for selectively maintaining the connecting arm in a user selected position.

5. The dolly cart of claim 4 wherein the locking element includes a locking pin movable between a non-locking position wherein the connecting arm is movable between the retracted and extending positions and a locking position wherein the connecting arm is fixed in the retracted position.

6. The dolly cart of claim 5 wherein the connecting arm includes an aperture therethrough and wherein locking pin is receivable in the aperture through the connecting aim with the connecting arm in the retracted position.

7. The dolly cart of claim 5 further comprising a lock handle and a push-pull cable operatively connecting the lock handle and the locking pin, the lock handle movable between an unlocking position wherein the push-pull cable moves the locking pin to the non-locking position and a locking position.

8. The dolly cart of claim 1 further comprising a floor lock operatively connected to the support frame, the floor lock movable between a retracted position wherein the dolly cart is free to travel over the supporting surface and an extended position wherein in the floor look is engageable with the supporting surface and discourages movement of the dolly cart along the supporting surface.

9. The dolly cart of claim 1 further comprising a bed mounted to the support frame for receiving the load thereon.

10. The dolly cart of claim 9 further comprising an anti-skid deck affixed to an upper surface of the dolly cart for discouraging movement of the load supported thereon.

11. The dolly cart of claim 1 wherein the striker element includes:
a bar having a first end pivotably received in a first end of the connecting arm and a second end; and
a ring interconnected to the second end of the bar.

12. A dolly cart for transporting a load over a supporting surface, comprising:
a support frame having a first and second ends;
a wheel assembly operatively connected to the support frame for supporting the support frame above a supporting surface;
a striker element operatively connected to the first end of the support frame, the striker element pivotable between a first position wherein the striker element is generally parallel to the supporting surface and second position wherein the striker element is at an acute angle to the supporting surface; and
a latch mechanism operatively connected to the second end of the support frame, the latch mechanism including a latch member having a hooked terminal end that partially defines a recess for receiving a portion of a striker element of an adjacent dolly cart therein.

13. The dolly cart of claim 12 wherein the terminal end of the latch member is pivotable between an open position wherein the striker element of the adjacent dolly cart may be inserted into and removed from the recess and a closed position for maintaining the striker element of the adjacent dolly cart in the recess.

14. The dolly cart of claim 13 further comprising a biasing structure for urging the latch member towards the closed position.

15 The dolly cart of claim 12 further comprising a connecting arm slidably supported by the support frame, the connecting arm movable between an extended position and a retracted position.

16. The dolly cart of claim 14 wherein the striker element includes:
a bar having a first end pivotably received in a first end of the connecting arm and a second end; and
a ring interconnected to the second end of the bar.

17. The dolly cart of claim 15 further comprising a handle operatively connected to the connecting arm for moving the connecting arm between the extend and retracted positions.

18. The dolly cart of claim 15 further comprising a locking element for selectively maintaining the connecting arm in a user selected position.

19. The dolly cart of claim 18 wherein the locking element includes a locking pin movable between a non-locking position wherein the connecting aim is movable between the retracted and extending positions and a locking position wherein the connecting arm is fixed in the retracted position.

20. The dolly cart of claim 19 wherein the connecting arm includes an aperture therethrough and wherein locking pin is receivable in the aperture through the connecting arm with the connecting arm in the retracted position.

21. The dolly cart of claim 19 further comprising a lock handle and a push-pull cable operatively connecting the lock handle and the locking pin, the lock handle movable between an unlocking position wherein the push-pull cable moves the locking pin to the non-locking position and a locking position.

22. The dolly cart of claim 12 further comprising a floor lock operatively connected to the support frame, the floor lock movable between a retracted position wherein the dolly cart is free to travel over the supporting surface and an extended position wherein in the floor look is engageable with the supporting surface and discourages movement of the dolly cart along the supporting surface.

23. The dolly cart of claim 12 further comprising a bed mounted to the support frame for receiving the load thereon.

24. The dolly cart of claim 23 further comprising an anti-skid deck affixed to an upper surface of the dolly cart for discouraging movement of the load supported thereon.

25. A dolly cart for transporting a load over a supporting surface, comprising:
a support frame having a first and second ends;
a bed mounted to the support frame for receiving the load thereon;
a wheel assembly operatively connected to the support frame for supporting the support frame above a supporting surface;
a connecting arm slidably supported by the support frame, the connecting arm having first and second ends and being movable between an extended position and a retracted position;
a striker element pivotably connected to the connecting arm, the striker element including:
a bar having a first end pivotably received in a first end of the connecting arm and a second end, the bar being movable between a first position wherein the bar is generally parallel to the supporting surface and second position wherein the bar is at an acute angle to the supporting surface; and
a ring interconnected to the second end of the bar;
a latch mechanism operatively connected to the second end of the support frame, the latch mechanism including a latch member having a hooked terminal end that partially a defines recess for receiving a ring of a striker element of an adjacent dolly cart therein; and
a floor lock operatively connected to the support frame, the floor lock movable between a retracted position wherein the dolly cart is free to travel over the supporting surface and an extended position wherein in the floor look is engageable with the supporting surface and discourages movement of the dolly cart along the supporting surface.

26. The dolly cart of claim 25 further comprising an anti-skid deck affixed to an upper surface of the dolly cart for discouraging movement of the load supported thereon.

27. The dolly cart of claim 25 further comprising a handle operatively connected to the connecting arm for moving the connecting arm between the extend and retracted positions.

28. The dolly cart of claim 25 further comprising a locking element for selectively maintaining the connecting arm in a user selected position.

29. The dolly cart of claim 28 wherein the locking element includes a locking pin movable between a non-locking position wherein the connecting arm is movable between the retracted and extending positions and a locking position wherein the connecting arm is fixed in the retracted position.

30. The dolly cart of claim 29 wherein the connecting arm includes an aperture therethrough and wherein locking pin is receivable in the aperture through the connecting arm with the connecting arm in the retracted position.

31. The dolly cart of claim 29 further comprising a lock handle and a push-pull cable operatively connecting the lock handle and the locking pin, the lock handle movable between an unlocking position wherein the push-pull cable moves the locking pin to the non-locking position and a locking position.
